(19) United States
(12) Patent Application Publication
(10) Pub. No.: US 2026/0136180 A1
(43) Pub. Date: May 14, 2026

(54) SYSTEM AND METHOD TO MANAGE DEVICE LOGIN AND AUTHENTICATION

(71) Applicant: Charter Communications Operating, LLC, St. Louis, MO (US)

(72) Inventors: Timothy Clark Bleidorn-Piper, Colorado Springs, CO (US); Cheryl A. Warne, Lone Tree, CO (US)

(21) Appl. No.: 18/947,388

(22) Filed: Nov. 14, 2024

(51) Int. Cl. H04W 12/06; H04L 12/66

(52) U.S. Cl. CPC H04W 12/06; H04L 12/66

(57) ABSTRACT

A communication management resource receives a request generated by a first communication device. The request from the first communication device requests use of a first wireless access service associated with a wireless access point providing connectivity to a remote network. The first communication device is assigned a first network address. A network address translator converts the first network address into a second network address. Via the second network address, the communication management resource derives an identity of a third network address assigned to a gateway through which the wireless access point provides the connectivity to the remote network. The communication management resource uses the third network address to determine account information indicating wireless services available to the first communication device via the wireless access point.

### BACKGROUND

Conventional mobile communication devices are typically configured with wireless antenna hardware to establish a respective wireless communication link with a wireless access point. The wireless access point provides the conventional mobile communication devices wireless services, such as connecting them to a respective remote network.

In certain instances, it is desirable to provide transparent login capabilities such that a respective mobile communication device is able to access a remote network through a wireless access point based upon a network address assigned to the mobile communication device. For example, an Internet service provider application can be configured to provide customers with access to services based on customer account entitlements (wireless services associated with a respective subscriber plan).

As part of a conventional activation process of providing wireless access, a respective wireless network service provider may provide a so-called Transparent Automatic Login (TAL) function, whereby a customer can simply attach their device to the service provider's network in their home. In such an instance, the application on the mobile communication device will automatically authenticate and attribute the appropriate wireless service in accordance with the customer's account.

A conventional authentication process and corresponding transparent automatic login may include:
1. When a user operates a respective application on a communication device to access the remote network through the wireless access point, the ISP_APP application executed on the mobile communication device sends an access request to an authentication system to authorize the requested wireless service. When the request is received by ISP's authentication system, the system looks at the source IP network address of the request (which corresponds to the NAPT-network address private translator-address of the router behind which the ISP_APP device sits) and performs a lookup for account information associated with a subscriber domain in which the wireless access point resides.
2. This lookup is possible because the ISP maintains a direct mapping of the source IP network address in the request to account/cable modem MAC address in a database.
3. The account lookup is completed, and the ISP's authentication system then authorizes the ISP_APP application on the communication device based on the account lookup.

### BRIEF DESCRIPTION OF EXAMPLES

There are deficiencies associated with conventional techniques of managing implementation of so-called transparent automatic login systems. For example, a typical transparent access login process works well with architectures that present a tight coupling between the IPV4 public network address used as the source address of the authentication request from the ISP_APP application executed on the mobile communication device and the MAC network address of a respective cable modem providing such service. However, there are certain instances where novel network architectures functionally ‘decouple’ the source IP network address associated with the application from the cable modem Mac network address. In such an instance, it is not possible to provide conventional transparent automatic login capabilities.

Techniques herein provide novel ways of providing so-called transparent access login capabilities to applications executed on respective communication devices.

In one example, a communication management resource receives a request from a first communication device requesting use of a first wireless access service associated with a wireless access point providing connectivity to a remote network. Assume that the first communication device assigned a first network address. Via the first network address, the communication management resource determines a second network address assigned to a gateway through which the wireless access point provides access to the remote network. The communication management resource or other suitable entity uses the second network address to determine wireless services available to the first communication device via the wireless access point.

In a further example, the request is an authentication request transmitted from the communication device to the wireless access point for use of the first wireless access service. In response to detecting that the first wireless access service requested by the communication device is supported by the available wireless services, the communication management resource communicates an authentication response to the communication device. The authentication response can be configured to indicate that the communication device has been authenticated to use the first wireless access service.

Yet further, note that the gateway as discussed herein can be any suitable resource. In one example, the gateway is a so-called cable modem disposed in a subscriber domain in which the wireless access point and the cable modem reside.

Still further, note that the operation of determining the second network address may include the communication management resource: translating the first network address into a third network address and port number (the port #may be randomly selected from a port #range); and detecting that the third network address and port correspond to a serviced network.

Additionally, the operation of determining the second network address may further include the communication management resource: via the third network address and the port number, obtaining tunnel information indicating identities of endpoints associated with multiple communication tunnels supported by the gateway.

Determination of the second network address may further include the communication management resource: using the tunnel information, obtaining a fourth network address assigned to the wireless access point; and using the fourth network address, determining the second network address assigned to the gateway.

In yet another example, the communication management resource using the second network address to determine the wireless services available to the first communication device may include the communication management resource: mapping the second network address to account information indicating the wireless services available to an account associated with a subscriber domain in which the wireless access point resides.

Yet further examples as discussed herein include the communication management resource determining the second network address based on operations of: translating the first network address into a third network address; and utilizing the third network address to determine if the request from the first communication device is associated with a supported wireless network.

As another example, the operation of determining the second network address may further include the communication management resource: obtaining tunnel information indicating identities of endpoints associated with multiple communication tunnels. The tunnel information may indicate that the wireless access point is or supports a termination node (and node or endpoint) of at least one tunnel as specified by the tunnel information.

Thus, examples herein provide novel ways of providing improved access to a wireless network providing one or more mobile communication device access to a remote network.

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium or computer readable storage hardware such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, executable instructions, etc., that supports operations as discussed herein.

One example includes a computer readable storage medium and/or system having instructions stored thereon to facilitate control or management of communications in a network environment. The instructions, when executed by computer processor hardware, cause the computer processor hardware (such as one or more co-located or disparately processor devices) to: receive a request from a first communication device requesting a first wireless access service associated with a wireless access point providing connectivity to a remote network, the first communication device assigned a first network address; via the first network address, determine a second network address assigned to a gateway through which the wireless access point provides access to the remote network; and use the second network address to determine wireless services available to the first communication device via the wireless access point.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless services to communication devices. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a first implementation of a network environment and authentication system supporting authentication and network access management as discussed herein.

FIG. 2 is an example communication flow diagram illustrating a successful authentication of user equipment to use respect of network services as discussed herein.

FIG. 3 is an example diagram illustrating a second implementation of a network environment supporting authentication and network access management as discussed herein.

FIG. 4 is an example communication flow diagram illustrating a failed attempt to determine network address services to provide to user equipment as discussed herein.

FIG. 5 is an example communication flow diagram illustrating successful authentication of user equipment using a novel authentication system as discussed herein.

FIG. 6 is a diagram illustrating example computer architecture to execute one or more operations as discussed herein.

FIG. 7 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

As discussed herein, a communication management resource receives a request generated by a first communication device. The request from the first communication device includes requested use of a first wireless access service associated with a wireless access point providing connectivity to a remote network. The first communication device is assigned a first network address. A network address translator converts the first network address into a second network address. Via the second network address, the communication management resource derives an identity of a third network address assigned to a gateway (such as a cable modem or other suitable entity) through which the wireless access point provides the connectivity to the remote network. The communication management resource uses the third network address to determine wireless services to provide to the first communication device via the wireless access point.

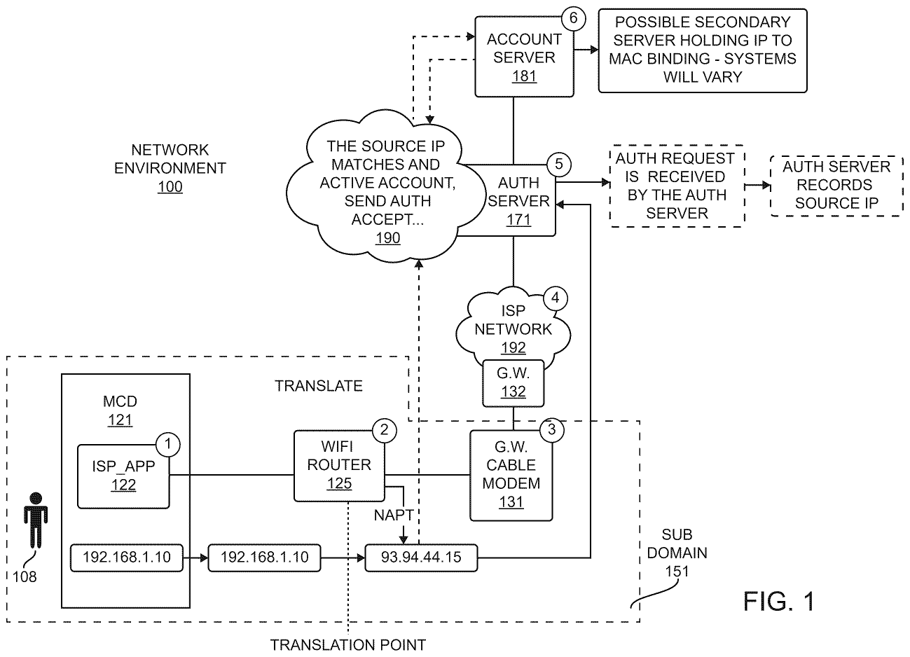

Now, with reference to the drawings, FIG. 1 is an example diagram illustrating a wireless network environment supporting authentication and network access as discussed herein.

This example illustrates a network environment supporting authentication according to a first method.

The network environment 100 in this example includes a mobile communication device 121, wireless access point 125, gateway 131, gateway 132, network 192, authentication server 171, and account server 181.

As shown, the mobile communication device 121, wireless access point 125, and the gateway 131 such as a cable modem are disposed in a subscriber domain 151. The head of household associated with the subscriber domain 151 may pay fees to use one or more services provided by the wireless access point 125 and corresponding service provider operating the network 192.

As shown, the mobile communication device 121 implements a respective application 122 supporting a respective first service such as content retrieval and playback. In order to use the first service, the mobile communication device 121 must be authenticated via the authentication server 171.

Further in this example, note that the mobile communication device 121 is assigned the network address 192.168.1.10.

The network environment 100 and corresponding complements support the following operations:
1. The mobile communication device executes the ISP_APP application 122 and requests authentication when attempting to connect to the network 192 through the wireless access point 125.
2. The wireless access point 125 (such as a Wi-Fi™ router or other suitable entity) performs NAPT (Network Address Port Translation) on the private address 192.168.1.10 assigned to the ISP_APP application 122 on the communication device 121, where the NAPT results in translation of the network address 192.168.1.10 into a public address 93.34.44.15. In general, the network address Port translation allows a single IP address to represent multiple devices on a private network to the outside world.
Note that each wireless access point/router in the network environment 100 may be assigned a dynamic single IPV4 network address for the purposes of network identification of the wireless access point itself as well as translation of multiple connected, privately addressed hosts to publicly routable hosts. In this example, the network address 93.34.44.15 assigned to the wireless access point 125 is used as the basis to perform authentication via so-called TAL (Transparent Automatic Login).
3. Further in this example, the gateway 131 such as a cable modem (CM) provides a DOCSIS (Data Over Cable Service Interface Specification) connection and is identified by its MAC address to northbound systems at time of provisioning. The MAC network address of the gateway 131 in this example is linked to the customer's account (head of household of subscriber domain 151) as a stable identifier.
4. The network 192 such as an Internet service provider (ISP) network provides transport services to destinations both internal and external to the network 192.
5. As further shown, the authentication server 171 is the destination to which the ISP_APP authentication requests are transmitted. Upon receiving a respective request having the source address 93.34.44.15, on behalf of the mobile communication device 121 corresponding application 122, the authentication server 171 performs the lookup of the cable modem MAC (gateway 131) associated with the source IP address used in the authentication request.
6. Additionally, the account server 181 provides mapping of the IP network address (93.34.44.15) to MAC network address of the gateway 131 (cable modem)- which may be stored in the billing/account database. Basically, any system that can associate IP addresses/MAC address to customer account information such as entitlements. The account server 181 provides access to the customer account information associated with the subscriber domain 151 such that the authentication server 171 is able to determine what services to provide to the requesting application 122 executed on the mobile communication device 121. Assuming that the customer account information associated with the subscriber domain 151 indicates to provide requested wireless services or other services, the authentication server 171 provides notification to the wireless access point 125 or other entities in the network that the mobile communication device 121 is authenticated to use the requested services associated with the application 122.

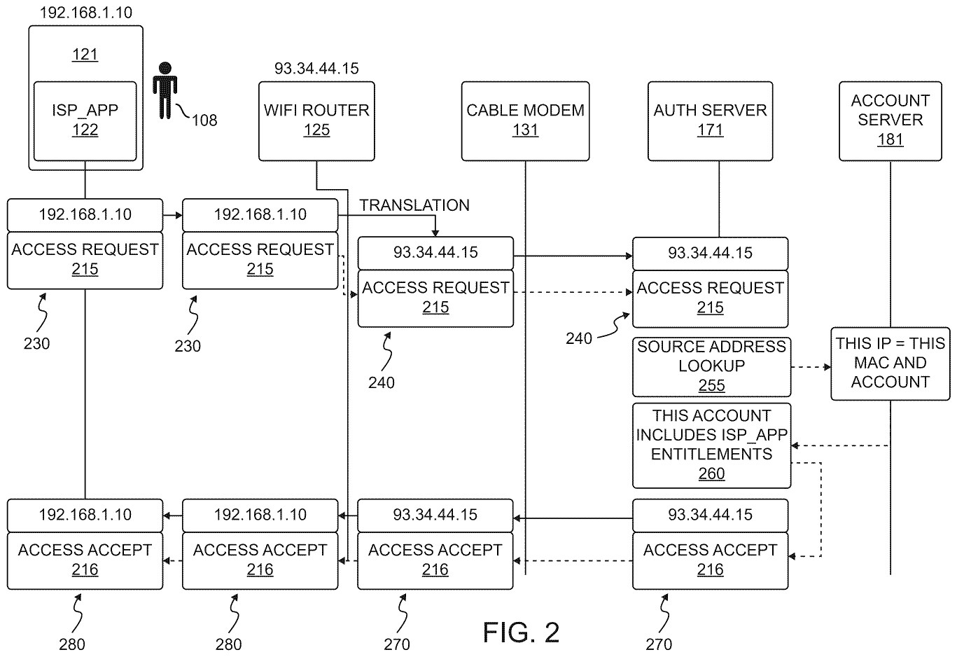

FIG. 2 is an example communication flow diagram illustrating a successful attempt to determine network services to provide to user equipment as discussed herein.

As previously discussed, the user 108 operating the mobile communication device 121 executes the application 122 to access the wireless access point 125 and corresponding one or more wireless services associated with the subscriber domain 151.

To use a respective wireless service associated with the application 122, the mobile communication device 121 generates communication 230 including an access request 215. The communication 230 includes a source network address assigned to the mobile communication device 121 for routing of the respective communication 230 to the authentication server 171.

As further shown, the wireless access point 125 receives the communication 230 and performs a network address translation from the source network address 192.168.1.10 to the new network address 93.34.44.15 assigned to the wireless access point 125. Thus, the communication 240 includes the original access request 215 as well as the source address 93.34.44.15 of the wireless access point 125.

The wireless access point 125 forwards the communication 240 including the access request 215 to the authentication server 171. Via the processing operation 255, the authentication server 171 performs a source address lookup via communications with the account server 181. For example, the authentication server 171 forwards the network address of the wireless access point 125 to the account server 181. The account server 181 maps the network address of the wireless access at 125 to the Mac address associated with the gateway 131 such as a cable modem. Accordingly, via the mapping, the account server 181 determines services associated with the subscriber domain 151. The account server 181 forwards notification of the services associated with the subscriber domain 151 to the authentication server 171. Accordingly, in processing operation 260, the authentication server 171 learns of the wireless or other services to be provided to communication devices operating in the subscriber domain 151.

As further shown, in response to detecting that the mobile communication device 121 and corresponding application 122 are authorized to use the requested wireless services as indicated by the access request 215, the authentication server 171 produces the access accept communications 270 including the acceptance information 216, which indicates that the application 122 and corresponding mobile communication device 121 are to be provided the requested access (services).

The authentication server 171 transmits the communications 270 to the wireless access point 125. The communications 270 include the destination address 93.34.44.15 assigned to the wireless access point 121 for routing purposes.

Yet further, the wireless access point 125 translates the destination network address into the network address assigned to the mobile communication device 121. For example, the wireless access point 125 produces the communications 280 to include the acceptance information 216 with a destination network address of 192.168.1.10 in order to support the subsequent conveyance of the communications 280 to the mobile communication device 121 and the corresponding application 122.

The mobile communication device 121 and corresponding application 122 thus receive the communications 280 indicating that use of the requested wireless services as specified by the access request have been granted as indicated by the access acceptance information 216.

The wireless access point 125 then provides the mobile communication device 121 and corresponding user 108 use of the requested wireless services to retrieve content for playback using the network 192.

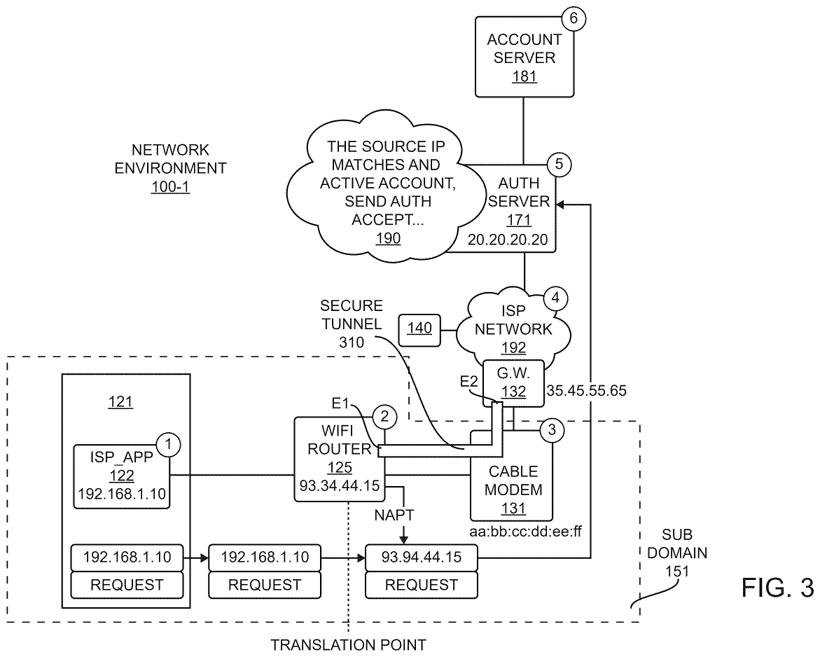

FIG. 3 is an example diagram illustrating a second implementation of a network environment supporting authentication and network access management as discussed herein.

In this example, the network environment 100-1 is similar to the network environment 100 as previously as discussed. However, in this example, the network environment 100-1 includes the gateway resource 132 assigned the network address 35.45.55.65. Additionally, the network environment 100-1 includes the secure communication tunnel 310 extending between the wireless access point 125 through the gateway 131 (such as a cable modem or other suitable entity) and the gateway 132.

In one example, the communication tunnel 310 (secured tunnel) supports encapsulation of data packets using any suitable protocol such as GRE (Generic Routing Encapsulation). Via the encapsulation protocol, the endpoints E1 and E2 of the secured tunnel 310 implement wrapping of respective data packets inside secondary data packets in order to set up a direct point-to-point network connection between the wireless access point 125 and the gateway 132. Accordingly, the wireless access point 125 serves as a first and point E1 of the secured tunnel 310 while the gateway 132 serves as a second end point E2 of the secured tunnel 310.

In one example, the gateway 132 is a so-called Broadband Network Gateway (BNG). In general, a Broadband Network Gateway (BNG) is a resource that allows subscribers to connect to a broadband network and access services from a respective Internet service provider such as associated with the network 192. The gateway 132 can be configured to: support connectivity where the gateway 132 acts as an access point for subscribers to connect to the broadband network, support traffic routing such as via aggregating traffic from subscribers and routing such traffic to and through the network 192, support authentication where the gateway 132 verifies user credentials and grants access only to authorized users and corresponding communication devices, support data packet delivery services enabling respective subscribers to receive various services (Internet, telephony, IPTV) via a single connection, and so on.

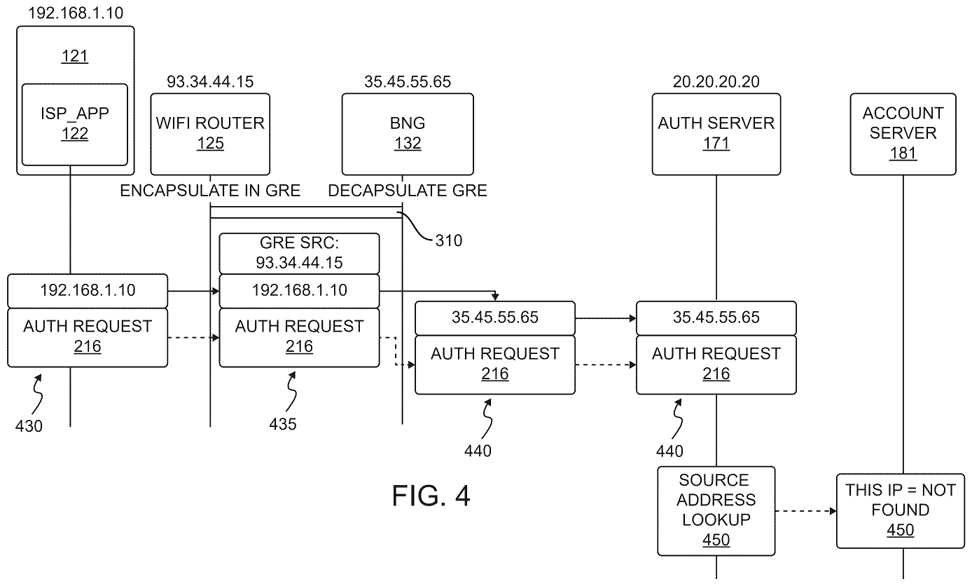

FIG. 4 is an example communication flow diagram illustrating a failed attempt to determine network address services to provide to user equipment in the second network environment 100-1 (in FIG. 3) as discussed herein.

In this example, assume that the same technique as previously discussed in FIG. 1 and FIG. 2 is used in the network environment 100-1 (FIG. 3) to authenticate a respective mobile communication device 121 and corresponding application 122 to use the requested services as indicated by the access request 216 (a.k.a., authentication request). FIG. 4 is an example communication flow diagram illustrating different communications amongst the entities in the network environment 100-1 to perform authentication.

For example, the mobile communication device 121 and corresponding application 122 generate the communications 430 including the authentication request 216. The mobile communication device 121 produces the communications 430 to include a respective source network address of 192.168.1.10 assigned to the mobile communication device 121. The mobile communication device 121 wirelessly communicates the communications 430 to the wireless access point 125.

As further shown, the wireless access point 125 derives the communications 435 from the received communications 430. The communications 435 include the access request 216, network address 192.168.1.10 (as a source network address) assigned to the mobile communication device 121, and the network address 93.34.44.15 (such as a GRE source network address) assigned to the wireless access point 125.

The wireless access point 125 transmits the communications 435 over the secure channel 310 to the gateway 132. The gateway 132 translates the network address 93.34.44.15 into the network address 35.45.55.65. The gateway 132 forwards the communications 440 to the authentication server 171. Accordingly, the authentication server 171 receives the respective access request 216.

In response to receiving the access request 216 in received communications 440, in processing operation 450, the authentication server 171 attempts to use the network address 35.45.55.65 assigned to the gateway 132 to wireless services associated with the subscriber domain 151. However, in this example, the account server 181 does not have a mapping of the network address of the gateway 132 to any subscriber information associated with the subscriber domain 151. Accordingly, the account server 181 and corresponding authentication server 171 are not able to use this method of authenticating the mobile communication device 121 and corresponding application 122 to use the requested services (216) associated with the network 192.

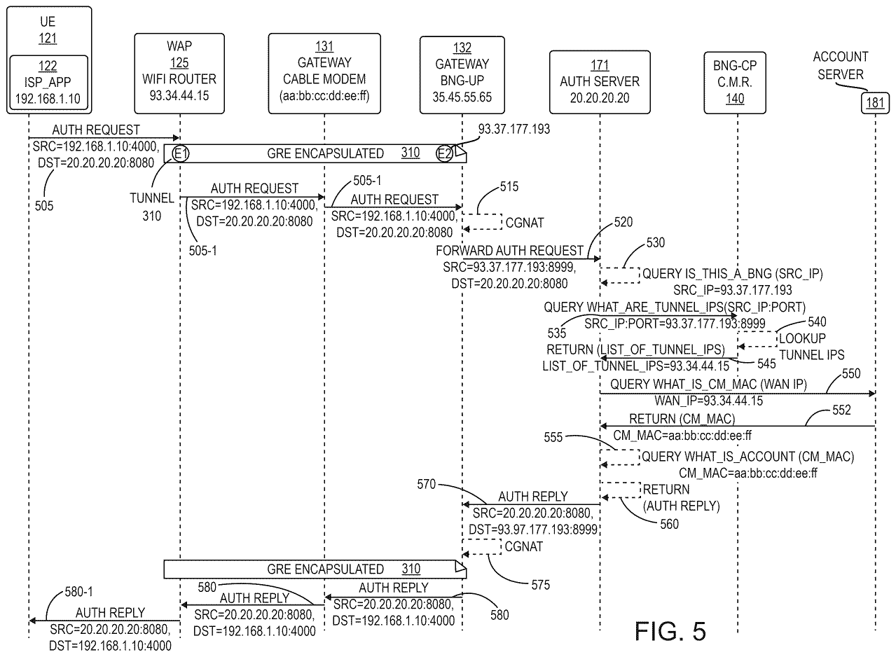

FIG. 5 is an example communication flow diagram illustrating an alternative method in which to determine services to provide to user equipment in the second implementation of the network environment as discussed herein.

In this novel method of authenticating a respective mobile communication device 121 and the application 122, the mobile communication device 121 and/or corresponding application 122 generates communication 505 to include an access request 216, a source network address 192.168.1.10 assigned to the mobile communication device 121 plus port information 4000, and a destination network address 20.20.20.20 assigned to the authentication server 171 and port information 8080. In a similar manner as previously discussed, the mobile communication device 121 wirelessly transmits communications 505 from the mobile communication device 121 to the wireless access point 125 for subsequent delivery to the authentication server 171 in order to use one or more wireless services associated with the subscriber domain 151.

As further shown, the wireless access point 125 encapsulates the received communications 505 into the communications 505-1 and transmits the communications 505-1 from the endpoint E1 of the secure tunnel 310 through the gateway 131 and the gateway 131 (assigned the network address AA:BB:CC:DD:EE:FF) to the endpoint E2 of the secure tunnel 310 disposed at the gateway 132 assigned the network address 35.45.55.65.

As further shown, in processing operation 515, the gateway 132 or other suitable entity implements a respective network address translation function (CGNAT) to convert the received source network address 192.168.1.10:port 4000 in the communications 505-1 into the public network address 93.37.177.193 (network address of the endpoint E2) and corresponding assigned random port 8988.

The gateway 132 produces the communications 520 (with authentication request) to include a source network address 93.37.177.193:8999 and a destination network address as network address 20.20.20.20 and port 8080. The communications 520 further include the original access request 216 (a.k.a., authentication request) to use the desired services supported by the network 192. The gateway 132 transmits the communications 520 to the authentication server 171.

In response to receiving the communications 520, the authentication server 171 or other suitable entity supports determination of whether the source network address 93.37.177.193 as indicated by the communications 520 corresponds to a network service supported by the service provider operating the network 192. In one example, this includes the authentication server 171 generating a respective query (530) including the source network address 93.37.177.193 (identity of the endpoint E2 of the tunnel 310). Assume that the response to the query in processing operation 530 indicates that the network associated with the source network address 93.37.177.193 corresponds to a network service supported by the service provider associated with the network 192.

In response to the positive response in processing operation 530 indicating that the network associated with the source network address 93.37.177.193 in communications 520 corresponds to a network service by the service provider associated with the network 192, the authentication server 171 generates the communications 535 to include a query of identity information associated secure tunnel endpoints associated with the network address 93.37.177.193 and corresponding port 8999. The authentication server 171 transmits communications 535 (such as a query to determine tunnel information associated with the network address 93.37.177.193) to the communication management resource 140 such as a control plane function associated with the gateway 132.

In response to receiving the communications 535, in processing operations 540, the communication management resource 140 performs a lookup of endpoint information (such as network addresses) associated with the network address 93.37.177.193:port 8988 assigned to the endpoint E2 of the secure tunnel 310. Assume that the resulting information associated with the endpoint information lookup reveals that the other end of the secure tunnel 310 associated with the endpoint E2 is endpoint E1 assigned or supported by an entity assigned the network address 93.34.44.15 (network address of the wireless access point 125). Via communications 545, the communication management resource 140 provides the learned network address endpoint information 93.34.44.15 associated with tunnel 310 to the authentication server 171. The communications 545 notify the authentication server 171 of the endpoint E1 and corresponding network address 93.34.44.15 associated with the wireless access 125.

In response to receiving the communications 545 indicating identity information associated with an endpoint of the secure tunnel 310, the authentication server 171 produces communications 550 including a query of a network address assigned to a gateway (such as a cable modem) associated with the network address 93.34.44.15 (wireless access point identity). The authentication server 171 transmits the communications 550 (with network address 93.34.44.15) to the account server 181. In response to receiving the communications 550 and corresponding query, the account server 181 maps the identity of the wireless access point 125 to the gateway 131 to determine the network address aa:bb:cc:dd:ee:ff assigned to the gateway 131 disposed in the subscriber domain 151, where the gateway 131 is determined to support the secured tunnel 310. The account server 181 transmits the communications 552 to the authentication server 171 notifying the authentication server 171 of the network address aa:bb:cc:dd:ee:ff associated with the gateway 131 such as a cable modem through which the tunnel 310 passes.

In response to receiving the communications 552 indicating the network address aa:bb:cc:dd:ee:ff assigned to the gateway 131, via the network address aa:bb:cc:dd:ee:ff, the authentication server 171 executes processing operation 555 to learn of (obtain) account information associated with the gateway 131 and corresponding subscriber domain 151. In other words, the authentication server 171 maps the network address aa:bb:cc:dd:ee:ff (identity) of the gateway 131 to wireless services available to the communication device 121 and corresponding subscriber domain 151. Thus, assume that the obtained account information from the mapping indicates what services are to be provided to the subscriber domain 151 including the gateway 131. Assume further in this example that the obtained account information associated with the network address aa:bb:cc:dd:ee:ff indicates to provide requested wireless service or services (as indicated by the access request 216) associated with application 122 executed by the mobile communication device 121.

In processing operation 560, the authentication server 171 or other suitable entity determines that the obtained account information associated with the subscriber domain 151 and corresponding gateway 131 supports the requested wireless service or services as indicated by the access request 216. In other words, the account information associated with the corresponding subscriber domain 151 indicates that the corresponding account is in good standing and that the requested wireless service should be granted. In response to this determination, the authentication server 171 generates and transmits communications 570 (such as including an authentication reply) from the authentication server 171 to the gateway 132. The authentication reply indicates to provide use of the requested service or wireless services to the communication device 121 and/or corresponding application 122.

More specifically, the authentication server 171 generates communications 570 to include a source network address 20.20.20:8080 assigned to the authentication server 171 and a destination network address 93.37.177.193:8999 assigned to the endpoint E2 of the secured tunnel 310 at gateway 132.

In response to receiving the communications 570, the gateway 132 performs a network address translation in processing operations 575, resulting in translation of the network address 93.97.177.193 into the network address 192.168.1.10. In other words, the network address translation is performed to deliver the communications 580 (such as an authentication reply communication) to the appropriate destination (i.e., application 122 executed on the mobile communication device 121). This includes generating the authentication reply communications 580 to include a source network address of 20.20.20.20:8080 and, as translated, a destination network address 192.168.1.10:port4000 assigned to the application 122 associated with the mobile communication device 121.

As previously discussed, the gateway 132 receiving the communications 570 determines that the path for communication of the authentication reply is through the secure tunnel 310. In such an instance, the gateway 132 encapsulates the received authentication reply in communications 570 to produce the encapsulated communications 580 and transmits such communications 580 through the secure tunnel to the gateway 131 such as a cable modem. The gateway 131 further forwards the authentication reply communications 580 through the secure tunnel 310 to the wireless access point 125.

The wireless access point 125 removes encapsulation of the received communications 580 to retrieve the authentication reply and forwards the corresponding authentication reply in communications 580-1 over a respective wireless communication link to the mobile communication device 121 and corresponding application 122. As previously discussed, the authentication reply communications 580-1 provide notification that the mobile communication device 121 and corresponding application 122 are to be provided the requested services as indicated by the original authentication request 505-1.

Subsequent to the notification that the application 122 and corresponding mobile communication device 121 are to be provided the requested services, the wireless network 192 and corresponding wireless access point 125 enable the application 122 and corresponding mobile communication device 121 to retrieve content via communications over the wireless access point 125, through the gateway 131 and gateway 132 as well as network 192.

Thus, the communication system as discussed herein includes communication processing resources (communication processing hardware, communication processing software, or combination of communication processing hardware and communication processing software) such as mobile communication device 121, wireless access point 125, gateway 131, gateway 132, authentication server 171, communication management resource 140, account server 181, etc.

From one perspective, via communications 520, the authentication server 171 receives a request (authentication request) originating from a first communication device 121 requesting use of a first wireless access service associated with a wireless access point 125 providing connectivity to a remote network 190 or simply the network 192. The first communication device 121 is assigned a network address of 192.168.1.10. Based on the network address 93.37.177.193 derived at least in part from the first network address 192.168.1.10 and transmission of communications 505-1 through the corresponding tunnel 310, the authentication server 171 determines a second network address aa:bb:cc:dd:ee:ff assigned to a gateway 131 such as a cable modem or other suitable entity through which the wireless access point 125 provides access and requested services to the remote network 190.

After determining the network address of the gateway 131, the authentication server 171 uses the second network address aa:bb:cc:dd:ee:ff (network address of the gateway 131) in processing operation 560 to determine wireless services available to the first communication device 121 via the wireless access point 125.

As previously discussed, in one example, the request from the application 122 and/or the mobile communication device 121 is an authentication request transmitted from the communication device 121 to the wireless access point 125 for use of the first wireless access service. In response to detecting that the first wireless access service requested by the communication device 121 is supported by the available wireless services assigned to the subscriber domain 151 such as operation 560, the authentication server 131 communicates an authentication response (such as communications 570) to the communication device 121 and corresponding application 122. The authentication response can be configured to indicate that the communication device 121 and corresponding application 122 have been authenticated to use the first wireless access service.

Further, as previously discussed, the gateway 131 may be a cable modem or other suitable entity disposed in a subscriber domain 151 in which the wireless access point 125 and the cable modem reside.

Determination of the second network address aa:bb:cc:dd:ee:ff may include the translation of the first network address 192.168.1.10:4000 by the gateway 132 (communication management resource translating the network address of the mobile communication device 121) into a third network address 93.37.177.193 and port number 8999 (such as a random port #). Additionally, via processing operation 530, determination of the second network address aa:bb:cc:dd:ee:ff may include detecting that the third network address 93.37.177.193 and port number 8999 correspond to a serviced network associated with the service provider and corresponding network 192.

Additionally, determination of the second network address aa:bb:cc:dd:ee:ff may include: i) via the third network address 93.37.177.193 and the port number 8999, obtaining tunnel information indicating identities of endpoints associated with multiple communication tunnels supported by the gateway 132; ii) using the tunnel information, obtaining a fourth network address 93.34.44.15 assigned to the wireless access point 125; and iii) using the fourth network address 93.34.44.15, determining (such as via mapping supported by account server 181 and communications 550 and 552) the second network address aa:bb:cc:dd:ee:ff assigned to the gateway.

Use of the second network address aa:bb:cc:dd:ee:ff to determine the wireless services available to the first communication device 121 may include: via the processing operation 555, mapping the second network address aa:bb:cc:dd:ee:ff to account information associated with the subscriber domain 151, where the account information indicates the wireless services available to an account associated with a subscriber domain 151 in which the wireless access point 125 resides.

Yet further, determination of the second network address aa:bb:cc:dd:ee:ff assigned to the gateway 131 may include: via the gateway 132, translating the first network address 192.168.1.10 into a third network address 93.37.177.193; and via processing operation 530, utilizing the third network address 93.37.177.193 to determine if the access/authentication request from the first communication device 151 is associated with a wireless network supported by the wireless network 192 and corresponding service provider.

Still further, determination of the second network address aa:bb:cc:dd:ee:ff may include the authentication server 171 obtaining tunnel information indicating identities of endpoints (such as including at least an point E1 and endpoint E2 associated with the tunnel 310) associated with multiple communication tunnels. The tunnel information may indicate the wireless access point 125 assigned network address 93.34.44.15 as being a termination node of at least one tunnel (such as associated with tunnel 310) as specified by the tunnel information.

Thus, the network address 93.37.177.193 assigned to the endpoint E2 of the gateway 132 is useful in determining a respective network address aa:bb:cc:dd:ee:ff of the gateway 131. For example, the authentication server 171 receives the communications 520 including the network address 93.37.177.193 of the endpoint E2 of the tunnel 310 at the gateway 132. The authentication server 171 communicates the network address 93.37.177.193 of the endpoint E2 of the tunnel to the communication management resource 140 that returns (via communications 545) the network address 93.34.44.15 of the endpoint E1 of the tunnel 310 such as supported by the wireless access point 125. The network address 93.34.44.15 of the wireless access point 125 is then used to determine the network address of the gateway 131, which is then used as a basis to determine one or more corresponding wireless services supported by the subscriber domain and corresponding wireless access at 125. If the requested wireless services indicated by the request from the communication device 121 is included in the one or more corresponding wireless services supported by the subscriber domain and corresponding wireless access point 125, the authentication server 171 initiates transmission of the authentication reply (allowing use of the requested service or services) to the mobile communication device 121 as previously discussed.

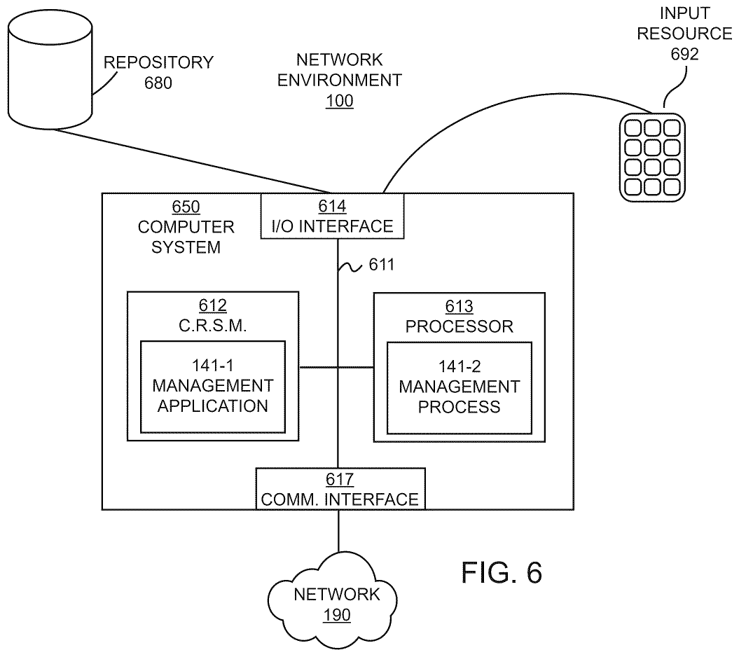

FIG. 6 is an example block diagram of a computer system for implementing any of the operations as previously discussed according to examples herein.

Any of the resources (such as communication device 121, wireless access point 125, gateway 131, gateway 132, authentication server 171, communication management resource 140, account server 181, etc.) as discussed herein can be configured to include computer processor hardware and/or corresponding executable instructions to carry out the different operations as discussed herein.

As shown, computer system 650 of the present example includes an interconnect 611 that couples computer readable storage hardware 612 such as a non-transitory type of media (which can be any suitable type of hardware storage medium in which digital information can be stored and retrieved), a processor 613 (computer processor hardware), I/O interface 614, and a communications interface 617.

I/O interface(s) 614 supports connectivity to repository 680 and input resource 692.

Computer readable storage hardware 612 can be any hardware storage device such as memory, optical storage, hard drive, floppy disk, etc. In one example, the computer readable storage hardware 612 stores instructions and/or data.

As shown, computer readable storage hardware 612 can be encoded with communication management application 140-1 (e.g., including instructions supporting execution of operation by any of the entities such as communication device 121, wireless access point 125, gateway 131, gateway 132, authentication server 171, communication management resource 140, account server 181, etc.) to carry out any of the operations as discussed herein.

During operation of one example, processor 613 accesses computer readable storage media 612 via the use of interconnect 611 in order to launch, run, execute, interpret or otherwise perform the instructions in management application 141-1 stored on computer readable storage medium 612. Execution of the communication management application 141-1 produces communication management process 141-2 to carry out any of the operations and/or processes as discussed herein.

Those skilled in the art will understand that the computer system 650 can include other processes and/or software and hardware components, such as an operating system that controls allocation and use of hardware resources to execute communication management application 141-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 650 may reside at any location or can be included in any suitable resource in any network environment to implement functionality as discussed herein.

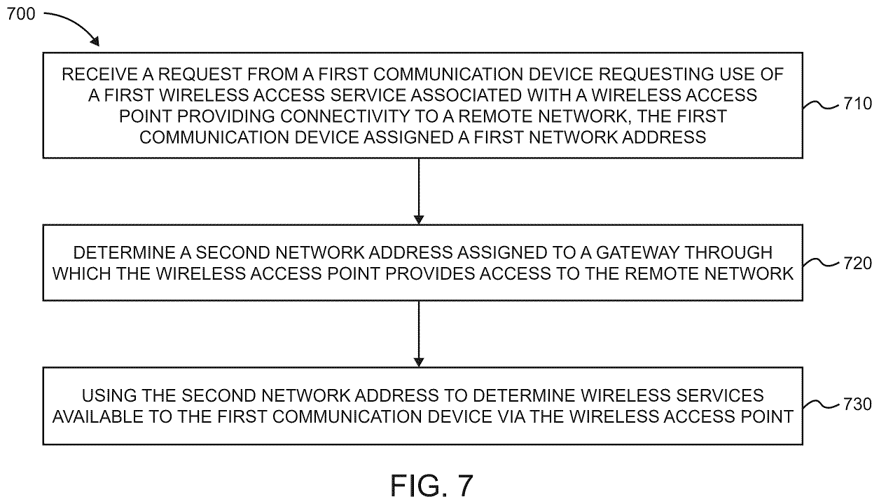

Functionality supported by the different resources will now be discussed via flowcharts in FIG. 7. Note that the steps in the flowcharts below can be executed in any suitable order.

FIG. 7 is a flowchart 700 illustrating an example method according to examples. Note that there will be some overlap with respect to concepts as discussed above.

In processing operation 710, the authentication server 171 or other suitable entity receives notification of a request from a first communication device requesting a first wireless access service from a wireless access point providing connectivity through a gateway 131 to a remote network, the first communication device assigned a first network address.

In processing operation 720, the authentication server 171 or other suitable entity determines a second network address assigned to the gateway through which the wireless access point provides access to the remote network.

In processing operation 730, the authentication server 171 or other suitable entity uses the second network address to determine wireless services available to the first communication device via the wireless access point.

Note again that techniques herein are well suited to facilitate control of tethering in a wireless network. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving a request from a first communication device requesting use of a first wireless access service associated with a wireless access point providing connectivity to a remote network, the first communication device assigned a first network address;
determining a second network address assigned to a gateway through which the wireless access point provides access to the remote network; and
using the second network address to determine wireless services available to the first communication device via the wireless access point.

2. The method as in claim 1, wherein the request is an authentication request transmitted from the communication device to the wireless access point for use of the first wireless access service.

3. The method as in claim 2 further comprising:
in response to detecting that the first wireless access service requested by the communication device is supported by the available wireless services, communicating an authentication response to the communication device, the authentication response indicating that the communication device has been authenticated to use the first wireless access service.

4. The method as in claim 1, wherein the gateway is a cable modem disposed in a subscriber domain in which the wireless access point and the cable modem reside.

5. The method as in claim 1, wherein determining the second network address includes:
translating the first network address into a third network address and port number; and
detecting that the third network address and port correspond to a serviced network.

6. The method as in claim 5, wherein determining the second network address further includes:
using the third network address and the port number to obtain tunnel information indicating associated with a communication tunnel through the gateway.

7. The method as in claim 6, wherein determining the second network address further includes:
via the tunnel information, determining a fourth network address assigned to the wireless access point; and
determining the second network address assigned to the gateway via the fourth network address.

8. The method as in claim 1, wherein using the second network address to determine the wireless services available to the first communication device include:
mapping the second network address to account information indicating the wireless services available to an account associated with a subscriber domain in which the wireless access point resides.

9. The method as in claim 1, wherein determining the second network address includes:
translating the first network address into a third network address; and
utilizing the third network address to determine if the request from the first communication device is associated with a supported wireless network.

10. The method as in claim 1, wherein determining the second network address further includes:
obtaining tunnel information indicating identities of endpoints associated with multiple communication tunnels, the tunnel information indicating the wireless access point as being an endpoint of at least one tunnel as specified by the tunnel information.

11. A system comprising:
communication management hardware operative to:
receive a request from a first communication device requesting use of a first wireless access service associated with a wireless access point providing connectivity to a remote network, the first communication device assigned a first network address;
determine a second network address assigned to a gateway through which the wireless access point provides access to the remote network; and
use the second network address to determine wireless services available to the first communication device via the wireless access point.

12. The system as in claim 11, wherein the request is an authentication request transmitted from the communication device to the wireless access point for use of the first wireless access service.

13. The system as in claim 11, wherein the communication management hardware is further operative to:
in response to detecting that the first wireless access service requested by the communication device is supported by the available wireless services, communicate an authentication response to the communication device, the authentication response indicating that the communication device has been authenticated to use the first wireless access service.

14. The system as in claim 11, wherein the gateway is a cable modem disposed in a subscriber domain in which the wireless access point and the cable modem reside.

15. The system as in claim 11, wherein the communication management hardware is further operative to:
translate the first network address into a third network address and port number; and
detect that the third network address and port correspond to a serviced network.

16. The system as in claim 11, wherein the communication management hardware is further operative to:
via the third network address and the port number, obtaining tunnel information indicating identities of endpoints associated with multiple communication tunnels supported by the gateway.

17. The system as in claim 16, wherein the communication management hardware is further operative to:
use the tunnel information, obtaining a fourth network address assigned to the wireless access point; and
use the fourth network address, determining the second network address assigned to the gateway.

18. The system as in claim 11, wherein the communication management hardware is further operative to:
map the second network address to account information indicating the wireless services available to an account associated with a subscriber domain in which the wireless access point resides.

19. The system as in claim 11, wherein the communication management hardware is further operative to:
translate the first network address into a third network address; and
as the third network address to determine if the request from the first communication device is associated with a supported wireless network.

20. The system as in claim 11, wherein the communication management hardware is further operative to:
obtain tunnel information indicating identities of endpoints associated with multiple communication tunnels, the tunnel information indicating the wireless access point as being a termination node of at least one tunnel as specified by the tunnel information.

21. Computer-readable storage hardware having instructions stored thereon, the instructions, when carried out by computer processor hardware, cause the computer processor hardware to:
receive a request from a first communication device requesting a first wireless access service associated with a wireless access point providing connectivity to a remote network, the first communication device assigned a first network address;
determine a second network address assigned to a gateway through which the wireless access point provides access to the remote network; and
use the second network address to determine wireless services available to the first communication device via the wireless access point.
